(19) United States
(12) Patent Application Publication
(10) Pub. No.: US 2003/0177877 A1
(43) Pub. Date: Sep. 25, 2003

(54) Adjustable live center apparatus

(76) Inventor: Tuyen Nguyen, Manchester, CT (US)

Correspondence Address: THEODORE R PAULDING, McCORMICK PAULDING & HUBER, 10 PENWOOD LANE, WETHERSFIELD, CT, 06109, US

(21) Appl. No.: 10/103,060

(22) Filed: Mar. 21, 2002

(51) Int. Cl. B23B 23/04

(52) U.S. Cl. 82/150

(57) ABSTRACT

A live center for use in a machine tool is provided that includes a center assembly, a shank, and apparatus for attaching the center assembly and the shank together. The shank includes an end surface and a centerline. The center assembly includes a center point, one or more bearings, and a housing. The housing has a cavity and a housing end surface. The one or more bearings and the center point are axially aligned with one another along a centerline, and are mounted within the cavity. The center assembly and the shank are relatively positioned such that at least a portion of the end surface of the shank is in contact with the end surface of the housing. The apparatus for attaching the center assembly to the shank permits relative lateral movement between the center assembly and the shank during set-up, to enable selective misalignment of the centerline of the center assembly and the centerline of the shank. The means for attaching the center assembly to the shank further permits the center assembly and the shank to be fixed relative to one another when the centerline of the center assembly and the centerline of the shank are misaligned.

### BACKGROUND OF THE INVENTION

1. Technical Field

This invention relates to live centers for use in supporting a workpiece to be machined while rotating about an axis in general, and to live centers that are adjustable in particular.

2. Background Information

Machine tools that rotate a workpiece along a horizontally extending axis typically employ a headstock and a tailstock to support the workpiece. During operation, the headstock is powered to rotate the work piece and the tailstock is stationary. The tailstock includes a center for engaging the workpiece. The center can be fixed relative to the tail stock (referred to as a “dead” center) or it can be rotatably mounted relative to the tail stock (referred to as a “live” center). During set-up of the machine tool, the tailstock is typically moved along a horizontally extending carriage away from the headstock to enable the workpiece to be engaged with the headstock. Subsequently, the tailstock is moved along the carriage in the opposite direction toward the headstock until the center of the tailstock engages the workpiece. If the tailstock has a dead center, the workpiece rotates relative to the center. If the tailstock has a live center, the center rotates with the workpiece. Ideally, the headstock, workpiece, and center are all axially aligned. In many instances, however, the axis of rotation of the tailstock center (also referred to herein as its “centerline”) is misaligned from the centerlines of the headstock and workpiece. Misalignment between the headstock, workpiece, and tailstock center centerlines can undesirably effect the machining process of the workpiece, and can also cause damage to the tailstock center and bearings.

Some tailstocks utilize a center that can be positionally adjusted via an eccentric bearing or spacer. A disadvantage of such an arrangement is that the tailstock must be sized to house the eccentric bearing or spacer assembly. A person of skill in the art will recognize there is considerable advantage in minimizing the size of the center. A smaller center is less apt to interfere during positioning of the machining tool relative to the workpiece in the area adjacent the tailstock. Another disadvantage of an eccentric bearing assembly within a center is the cost of the eccentric bearing. Eccentric bearings are typically more expensive that similar aligned bearings. Another disadvantage of the some of the centers having an eccentric bearing is that they can be difficult and/or time consuming to align.

What is needed, therefore, is a live center for use in a machine tool that is less likely to interfere with machine tool positioning than currently available centers, one that is relatively inexpensive, and one that facilitates alignment.

### DISCLOSURE OF THE INVENTION

According to the present invention, a live center for use in a machine tool is provided that includes a center assembly, a shank, and means for attaching the center assembly and the shank together. The shank includes an end surface and a centerline. The center assembly includes a center point, one or more bearings, and a housing. The housing has a cavity and a housing end surface. The one or more bearings and the center point are axially aligned with one another along a centerline, and are mounted within the cavity. The center assembly and the shank are relatively positioned such that at least a portion of the end surface of the shank is in contact with the end surface of the housing. The means for attaching the center assembly to the shank permits relative lateral movement between the center assembly and the shank during set-up, to enable selective misalignment of the centerline of the center assembly and the centerline of the shank. The means for attaching the center assembly to the shank further permits the center assembly and the shank to be fixed relative to one another when the centerline of the center assembly and the centerline of the shank are misaligned.

An advantage of the present invention live center is that it facilitates alignment of the centerlines of the center point, workpiece, and headstock. Some prior art centers do not permit alignment. Others utilize eccentric bearings and/or spacers to align the center point, workpiece, and headstock centerlines. Many of the devices that utilize eccentric bearings and/or spacers can be adjusted, but must be done manually by rotating eccentric components or adjusting set screws, etc. A person of skill in the art will recognize that such a procedure is time consuming and therefore undesirable. The present device, in contrast, can easily be aligned by loosening the means for attaching the center assembly and the shank together and subsequently engaged the centerpoint with the workpiece. The mating geometries between the centerpoint and a chamfered aperture disposed on an end of the workpiece cooperate to align the center assembly with the workpiece and headstock. Once aligned, the center assembly and shank are fixed together by the means for attaching.

Another advantage of the present invention live center is that it provides a low profile live center. In the present device, the entire center assembly can be moved when necessary to align the centerlines of the center assembly and the headstock. Because the entire center assembly can be moved laterally for alignment purposes, there is no need to utilize an internal eccentric bearing or spacer enclosed within a housing. Hence, the size of the housing is kept to a minimum and therefore less apt to provide undesirable interference with the machine tool.

Another advantage of the present invention is that a cost-effective live center is provided that can be adjusted to accommodate misalignment. The simplicity of the present device makes it a cost-effective alternative to live centers that utilize complex mechanisms to accommodate misalignment.

These and other objects, features, and advantages of the present invention will become apparent in light of the detailed description of the present invention.

### BRIEF DESCRIPTION OF THE DRAWINGS

FIG. 1 is a diagrammatic sectioned view of an embodiment of the present invention live center illustrating the center assembly and shifted relative to one another.

FIG. 2 is another view of the live center embodiment shown in FIG. 1, illustrating the center assembly and shifted relative to one another in the direction opposite that shown in FIG. 11.

FIG. 3 is a diagrammatic sectioned view of a second embodiment of the present invention live center illustrating the center assembly and shifted relative to one another.

FIG. 4 is a diagrammatic sectioned view of a third embodiment of the present invention live center illustrating the center assembly and shifted relative to one another.

### DETAILED DESCRIPTION OF THE INVENTION

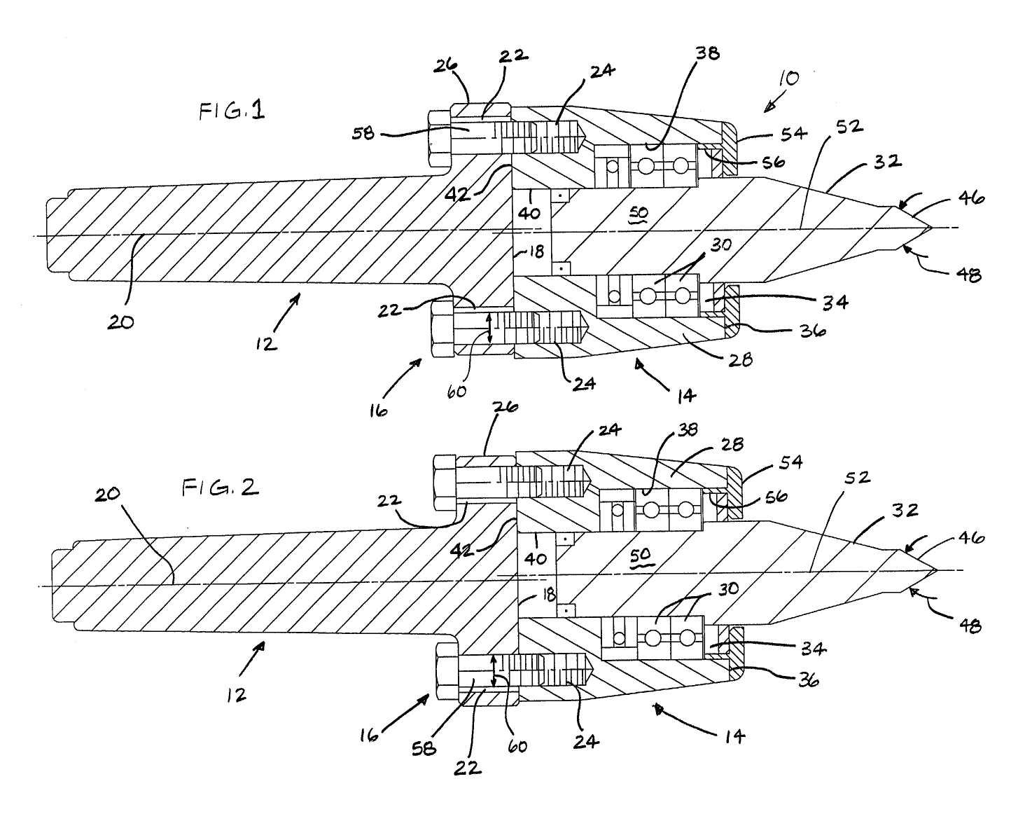

Referring to FIGS. 1-4, a live center 10 for use in a machine tool is provided that includes a shank 12, a center assembly 14, and means 16 for attaching the center assembly 14 to the shank 12. The shank 12 is sized to fit within and be attached to a tailstock of a machine tool (not shown). The shank 12 includes an end surface 18. The shank 12 may be tapered or constant in diameter along an axial centerline 20. As used herein, unless otherwise specified, the term “centerline” refers to the rotational axis of the element. The shank 12 includes one or more clearance apertures 22 (see FIGS. 1 and 2), or one or more threaded apertures 24 (see FIG. 3), or some combination thereof. The shank 12 may include an attachment flange 26, and the clearance aperture(s) 22 and/or threaded aperture(s) 24 may be disposed in the attachment flange 26.

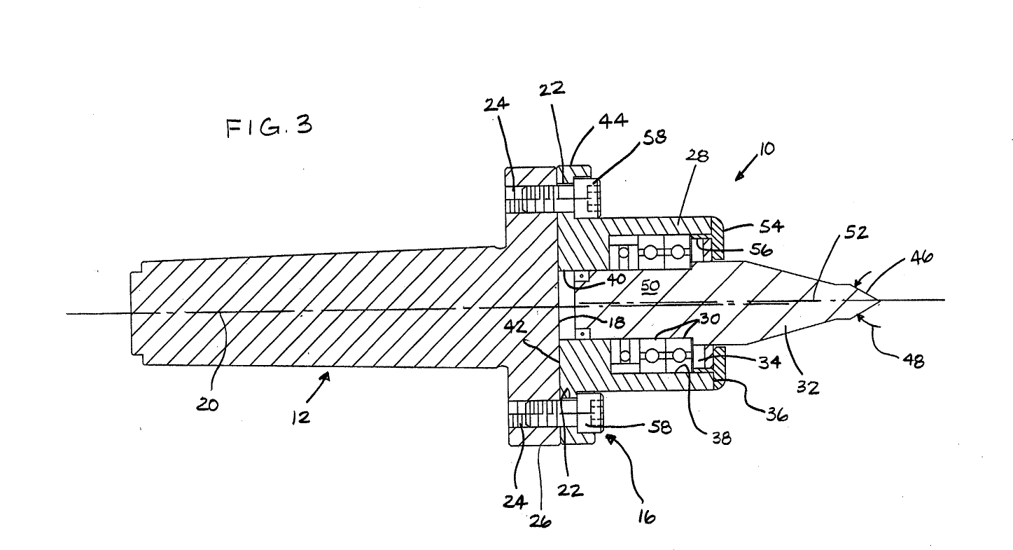

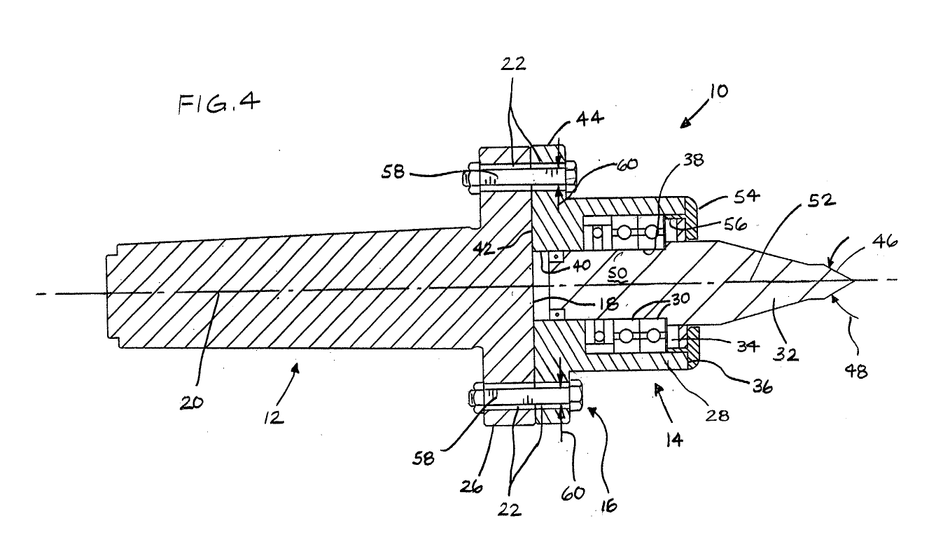

The center assembly 14 includes a housing 28, one or more bearings 30, and a center point 32. The housing 28 includes a cavity 34 disposed in a first axial end surface 36. The cavity 34 is sized to receive the one or more bearings 30. The embodiments shown in FIGS. 1-4 show the cavity 34 having a first bore 38 and a second bore 40. The first bore 38 is sized to receive the one or more bearings 30 and the second bore 40 is sized to receive a portion of the shank 12. In alternative embodiments, the cavity 34 may include a plurality of bores for receiving multiple bearings, seals, retaining clips, etc., and is therefore not limited to any particular configuration. The housing 28 further includes one or more clearance apertures 22 (see FIG. 3), or one or more threaded apertures 24 (see FIGS. 1 and 2), or some combination thereof disposed in a second axial end surface 42. The housing 28 may also include an attachment flange 44 (see FIGS. 3 and 4), and the clearance aperture(s) 22 and/or threaded aperture(s) 24 may be disposed in the attachment flange 44. In some embodiments, the housing 28 may be asymmetrically shaped to provide additional clearance for machine tools.

The bearings 30 facilitate rotational motion between housing 28 and the center point 32. The type of bearing 30 can be varied to suit the application at hand. For example, the amount of axial load and radial load applied to the bearing 30 can vary greatly from application to application, in which case the type of bearing would be selected to accommodate the specific magnitudes of axial and radial loadings. Acceptable bearing types include, but are not limited to, ball bearings, roller bearings, tapered roller bearings, sleeve bearings, etc.

The center point 32 includes a conical end 46 having a taper angle 48 that may form into a point or may be truncated. The taper angle 48 is chosen to facilitate engagement with the workpiece. The center point 32 further includes a journal 50 that is sized to be receivable within the one or more bearings 30. The bearing 30 and the center point 32 are coaxial with one another along a centerline 52.

In the embodiments shown in FIGS. 1-4, the center assembly 14 further includes a bearing cap 54 attached to the housing 28 over the cavity 34. The bearing cap 54 includes a bearing race flange 56 for retaining the bearings 30. The bearing cap 54 may be asymmetrically shaped to provide additional clearance for machine tools. Other mechanisms for retaining the one or more bearings 30 within the cavity 34 can be used alternatively. The center assembly 14 may also include one or more seals (not shown) to prevent or inhibit dust and machining debris from entering the cavity 34.

The means 16 for attaching the center assembly 14 to the shank 12 permits relative lateral movement between the center assembly 14 and the shank 12 along the respective end surfaces 18,42 during set-up to enable selective misalignment of the centerline 52 of the center assembly 14 and the centerline 20 of the shank 12 if necessary. The respective end surfaces 18,42 are preferably substantially parallel to facilitate lateral movement. The means 16 for attaching the center assembly 14 to the shank 12 also permits the center assembly 14 and the shank 12 to be fixed relative to one another when the centerline 52 of the center assembly 14 and the centerline 20 of the shank 12 are misaligned. In the preferred embodiment, the means 16 for attaching the center assembly 14 to the shank 12 includes a plurality of fasteners 58 (e.g., screws, bolts, etc.) to attach the center assembly 14 and the shank 12 to one another. Each fastener 58 extends through a clearance aperture 22 in one of the shank 12 or the center assembly 14 and is threadably engaged with a threaded aperture 24 in the other of the shank 12 or the center assembly 14. The portion of each fastener 58 received within a clearance aperture 22 has a lateral width 60. If the fastener portion is cylindrical, for example, then the lateral width 60 is the diameter of the portion. For ease of explanation, the lateral width 60 of the portion is referred to hereafter as the “diameter” of the portion. The portion of a fastener 58 received within a clearance aperture 22 is not, however, limited to a circular cross-section. The clearance between the fasteners 58 and the clearance apertures 22 permits lateral movement between the center assembly 14 and the shank 12 during set-up to enable selective misalignment of the centerline 52 of the center assembly 14 and the centerline 20 of the shank 12. Alternatively, lateral movement can be accomplished by utilizing clearance apertures 22 in both the center assembly 14 and the shank 12 (see FIG. 4). Bolts having a smaller diameter than the clearance apertures 22 can be used with nuts to fasten the center assembly 14 and the shank 12 together. In still another embodiment, the center assembly 14 and shank 12 can be attached to one another by a first fastener or pivot rod, and at least one second fastener received within a clearance aperture 22, including a slot-type aperture. The pivot rod (or equivalent) would enable relative rotational movement between the center assembly 14 and the shank 12 and the second fastener(s) would be used to fix the two together.

In the operation of the live center 10, the shank 12 is inserted within a tailstock (not shown) and clamped or otherwise fixed within the tailstock. The means 16 for attaching the center assembly 14 to the shank 12 is adjusted to permit relative lateral movement between the center assembly 14 and the shank 12. In the embodiment shown in FIGS. 1-4, for example, the fasteners 58 are loosened enough to allow relative lateral motion between the center assembly 14 and shank 12. The centerline 52 of the center point 32 is then aligned with the centerline of the headstock, and the center assembly 14 is fixed to the shank 12; e.g., the fasteners 58 are tightened. In this fixed position, the centerline 20 of the shank 12 and the centerline 52 of the center assembly 14 may be aligned with one another or they may be offset from one another. Either way, the centerline of the workpiece is aligned with the centerline 52 of the center assembly 14. As a result, the problems of misalignment are avoided.

The alignment of the center assembly 14 centerline and the headstock centerline can be accomplished in a variety of ways. In one method, the workpiece is provided with a chamfered hole in one end (not shown). The geometry of the chamfered hole is chosen to mate with the conical end 46 of the center point 32. The loosened center assembly 14 is engaged with the workpiece clamped within the headstock and the mating conical end 46 and chamfered hole positionally guide one another until both are axially aligned. Once the center point 32 (and therefore center assembly) and workpiece are axially aligned, then the fasteners 58 are tightened to fix the center assembly 14 to the shank 12. In another method, an indicator (not shown) attached to the headstock is used to indicate axial alignment between the center point 32 and the headstock. If the center point 32 is axially misaligned, the fasteners 58 are loosened and the center assembly moved until the center point 32 and the headstock are axially aligned with one another. In still another method, the center assembly 14 is pivoted around a pivot pin and therefore shifted relative to the shank 12. A fastener 58 received within a clearance aperture 22 (including a slot-type aperture) is used to fix the center assembly 14 and the shank 12 together. Other methods of aligning the center assembly 14 with the headstock, and therefore the workpiece may be used alternatively.

Although this invention has been shown and described with respect to the detailed embodiments thereof, it will be understood by those skilled in the art that various changes in form and detail thereof may be made without departing from the spirit and scope of the invention.

What is claimed is:

1. A live center for use in a machine tool, comprising:
a center assembly having a center point, a bearing, and a housing that includes a cavity, wherein the bearing and the center point are axially aligned with one another along a first centerline and mounted within the cavity;
a shank having a second centerline; and
means for attaching the center assembly to the shank;
wherein the means for attaching the center assembly to the shank permits relative lateral movement between the center assembly and the shank during set-up, thereby enabling selective misalignment of the first centerline and the second centerline, and permits the center assembly and the shank be fixed relative to one another when the first centerline and the second centerline are misaligned.

2. The live center of claim 1 wherein the means for attaching includes one or more fasteners, each having a diameter;
wherein the shank includes one or more clearance apertures for receiving the one or more fasteners, and each clearance aperture has a diameter that is greater than the diameter of the fastener received therein, thereby creating a clearance space between the fastener and the clearance aperture.

3. The live center of claim 2, wherein the housing includes one or more threaded apertures, wherein each of the one or more fasteners extends through one of the one or more clearance apertures and is threadably engaged with one of the one or more threaded apertures.

4. The live center of claim 3, wherein the shank includes a first attachment flange, and the one or more clearance apertures are disposed within the first attachment flange.

5. The live center of claim 4, wherein the housing includes a second attachment flange, and the one or more threaded apertures are disposed within the second attachment flange.

6. The live center of claim 5, wherein the housing includes a first housing axial end surface and the shank includes a shank axial end surface, and the first housing axial end surface and the shank axial end surface are substantially parallel one another.

7. The live center of claim 1 wherein the means for attaching includes one or more fasteners, each having a diameter;
wherein the housing includes one or more clearance apertures for receiving the one or more fasteners, and each clearance aperture has a diameter that is greater than the diameter of the fastener received therein, thereby creating a clearance space between the fastener and the clearance aperture.

8. The live center of claim 7, wherein the shank includes one or more threaded apertures, wherein each of the one or more fasteners extends through one of the one or more clearance apertures and is threadably engaged with one of the one or more threaded apertures.

9. The live center of claim 8, wherein the housing includes a first attachment flange, and the one or more clearance apertures are disposed within the first attachment flange.

10. The live center of claim 9, wherein the shank includes a second attachment flange, and the one or more threaded apertures are disposed within the second attachment flange.

11. The live center of claim 10, wherein the housing includes a first housing axial end surface and the shank includes a shank axial end surface, and the first housing axial end surface and the shank axial end surface are substantially parallel one another.

12. The live center of claim 1 wherein the means for attaching includes one or more fasteners, each having a diameter; and
wherein the housing and the shank each includes one or more clearance apertures for receiving the one or more fasteners, and each clearance aperture has a diameter that is greater than the diameter of the fastener received therein, thereby creating a clearance space between the fastener and the clearance aperture.

13. The live center of claim 1 further comprising a bearing cap having an aperture for receiving the center point, wherein the bearing cap is attached to the housing over the cavity.

14. A method of aligning a workpiece mounted for rotation within a machine tool, comprising the steps of:
providing an aperture on an end surface of the workpiece, wherein the aperture is aligned with the a centerline of the workpiece;
providing a live center that includes
a center assembly having a center point and a centerline,
a shank; and
means for attaching the center assembly to the shank;
attaching the center assembly to the shank using the means for attaching in a manner that allows relative lateral movement between the center assembly and the shank;
engaging the centerpoint with the aperture disposed in the end surface of the workpiece an amount sufficient to align the centerline of the center assembly with the centerline of the workpiece; and
attaching the center assembly to the shank using the means for attaching in a manner that prevents relative lateral movement between the center assembly and the shank during operation of the machine tool.
